(19) United States
(12) Patent Application Publication
(10) Pub. No.: US 2011/0107194 A1
(43) Pub. Date: May 5, 2011

(54) SYSTEM, METHODS, AND USER INTERFACE FOR CONVENIENTLY CREATING CITATIONS IN A DOCUMENT

(76) Inventor: Xu Cui, Fremont, CA (US)

(21) Appl. No.: 12/613,218

(22) Filed: Nov. 5, 2009

(51) Int. Cl. G06F 17/21; G06F 3/048

(52) U.S. Cl. 715/206; 715/810

(57) ABSTRACT

A computer-implemented method for creating citations for a document is disclosed. The method includes receiving, by a computer processor, text from a user via a keyboard in communication with the computer processor; displaying the text on a user interface on a display device in communication with the computer processor; receiving a symbol from the user via the keyboard, wherein the symbol is not part of the content of the text; displaying the symbol adjacent to the text in the user interface; retrieving, by the computer processor, a first list of citation references from a computer storage after the symbol is displayed in the user interface; displaying the first list of citation references at the user interface to allow at least one of the first list of citation references to be selected; and inserting the selected citation reference near the symbol in the text in the user interface.

### BACKGROUND

The present application relates to reference citation in documents, and more particularly, creating citation in a word processing environment.

It is generally recognized that the world economic order is shifting from one based on manufacturing to one based on the generation, organization and use of information. For example, scientific literature continues to be produced at a rapid rate, making it time consuming for researchers to stay current. Most published scientific research appears in paper documents such as scholarly journals or conference proceedings, which include citations to other scientific papers. A researcher could spend large amounts of time for searching, organizing, and citing appropriate references at the proper locations in a publication.

Referring to FIG. 1A-1C, an exemplified conventional user interface 1 includes a text field 2 for an author to enter and edit text with the keyboard 105. The user interface 1 also includes a button 3 for inserting citation references. The author uses a keyboard to enter text such as “Insert citation” in the text field 2 (FIG. 1A). To inset a citation such as a scientific publication, the author switches to a mouse to click the button 3. A window 5 pops up, showing a list of citation references 6 (FIG. 1B). The author can use the mouse to select one of the citation references 6. The citation is inserted (FIG. 1C).

One drawback associated with the conventional citation tools is that the author has to break away from his or her writing workflow by switching from a keyboard to mouse in order to find and insert a citation to a reference publication. Another challenge for citation tools is to allow an author to easily find the right references from a large number of publications.

Accordingly, a need has been identified for tools that can assist users to conveniently create citations in their publications.

### SUMMARY

In a general aspect, the present invention relates to a computer-implemented method for creating citations for a document. The method can include receiving, by a computer processor, text from a user via a keyboard in communication with the computer processor; displaying the text on a user interface on a display device in communication with the computer processor; receiving a symbol from the user via the keyboard, wherein the symbol is not part of the content of the text; displaying the symbol adjacent to the text in the user interface; retrieving, by the computer processor, a first list of citation references from a computer storage after the symbol is displayed in the user interface; displaying the first list of citation references at the user interface to allow at least one of the first list of citation references to be selected; and inserting the selected citation reference near the symbol in the text in the user interface.

In another general aspect, the present invention relates to a computer-implemented method for creating citations for a document. The method can include receiving, by a computer processor, text from a user via a keyboard in communication with the computer processor; displaying the text at a user interface on a display device in communication with the computer processor; retrieving, by the computer processor, a first list of citation references from a computer storage in response to a keystroke or the pressing of a combination of keys on the keyboard; displaying the first list of citation references in the user interface to allow at least one of the first list of the citation references to be selected; and inserting the selected reference in the text at the user interface.

In another general aspect, the present invention relates to a computer program product that includes a computer useable medium having computer readable program code functions embedded in said medium for causing a computer to receive, by a computer processor, text from a user via a keyboard in communication with the computer processor; display the text on a user interface on a display device in communication with the computer processor; receive a symbol from the user via the keyboard, wherein the symbol is not part of the content of the text; display the symbol adjacent to the text in the user interface; retrieve, by the computer processor, a first list of citation references from a computer storage after the symbol is displayed in the user interface; display the first list of citation references at the user interface to allow at least one of the first list of citation references to be selected; and insert the selected citation reference near the symbol in the text in the user interface.

Implementations of the system may include one or more of the following. The computer-implemented method can further include selecting at least one of the first list of the citation references by the user before the step of inserting. The step of selecting can be conduced by the user using the keyboard. The user interface can include a word processing environment that includes a text field configured to display text entered by the user; and an activatable function configured to receive a selection of a citation format for the selected reference in the text displayed in the user interface. The user interface can include an activatable function. The computer-implemented method can further include activating the activatable function after the symbol is displayed adjacent to the text at the user interface; and skipping the insertion of the selected citation reference while keeping the symbol displayed adjacent to the text. The computer-implemented method can further include selecting, by the user, a citation format for the citation reference in the text displayed in the user interface. The computer-implemented method can further include receiving, from the user, information about the citation reference to be inserted; and producing a dynamic list of citation references to allow the user to select a citation reference in the dynamic list of citation references. The symbol can include one or a combination of “#”, “̂”, “&”, “*”, “˜”, “{”, “}”, “[”, “]”, “<”, “>”, “;”, “((”, or “))”.

The systems and methods described in the present application provide convenient and intuitive tools for creating citation in a word processing environment. An author of a document does not have to break away from her normal writing flow to search and insert citations. The author can use the same keyboard for word processing to conveniently embed citations of publications. The author does not need to pause her writing flow to switch from keyboard to mouse or touch pad to make a citation insertion. A list of references can be dynamically selected by semantic understanding of the citation information entered by the author, which makes the citation insertion fast and easy. The format of citations can be easily selected as required by the specific journal publication.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIGS. 1A-1C illustrate a user interface for incorporating a citation in a word processing environment in a conventional system.

FIG. 2 illustrates a diagram of a computer system compatible with the present invention.

FIGS. 3A-3K illustrate an exemplified user interface showing detailed steps for incorporating a citation in a word processing environment.

FIG. 4 is a flow chart for incorporating a citation in a word processing environment in accordance with the present invention.

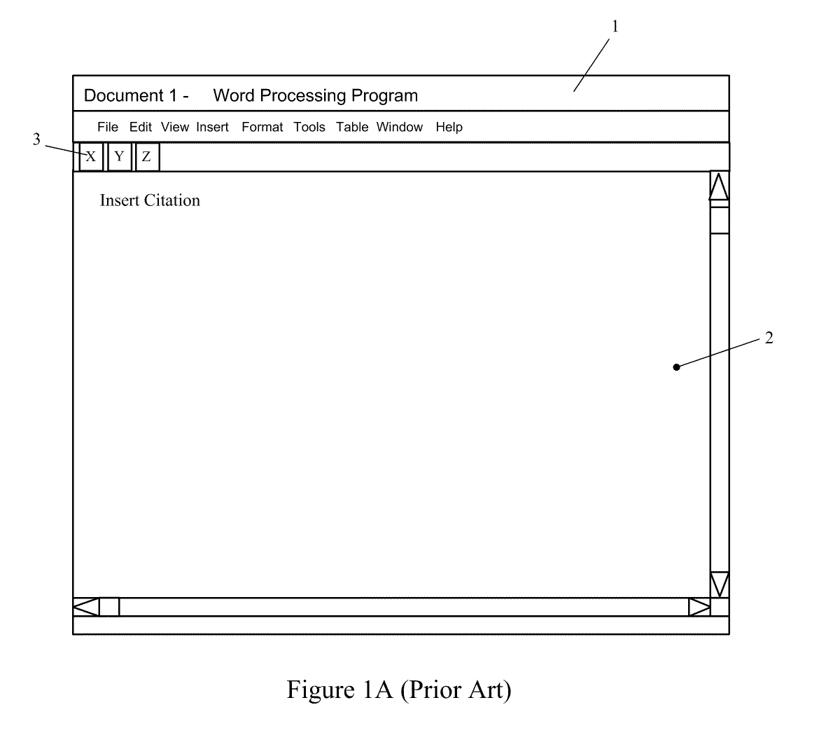

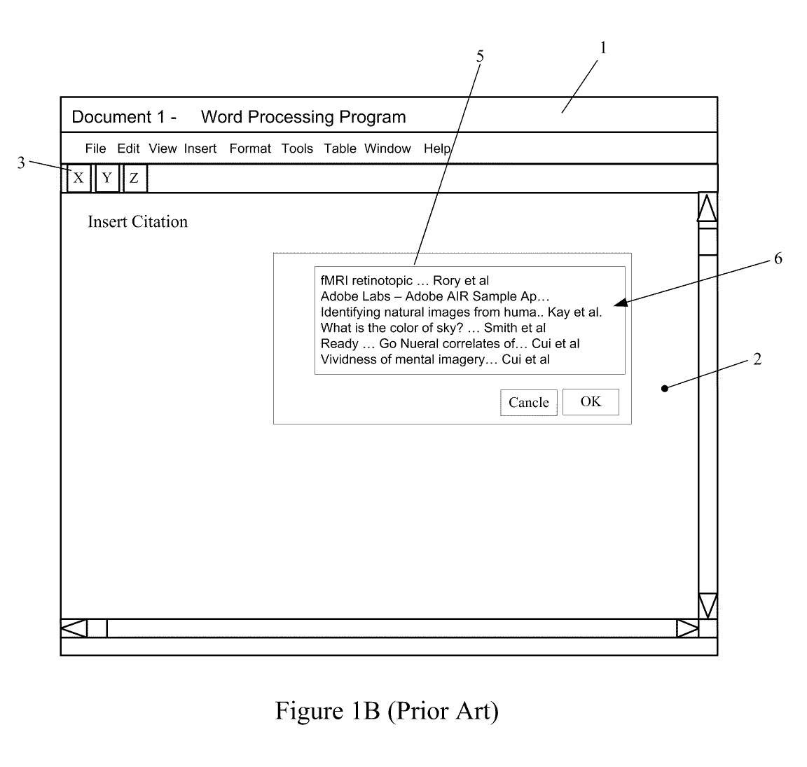

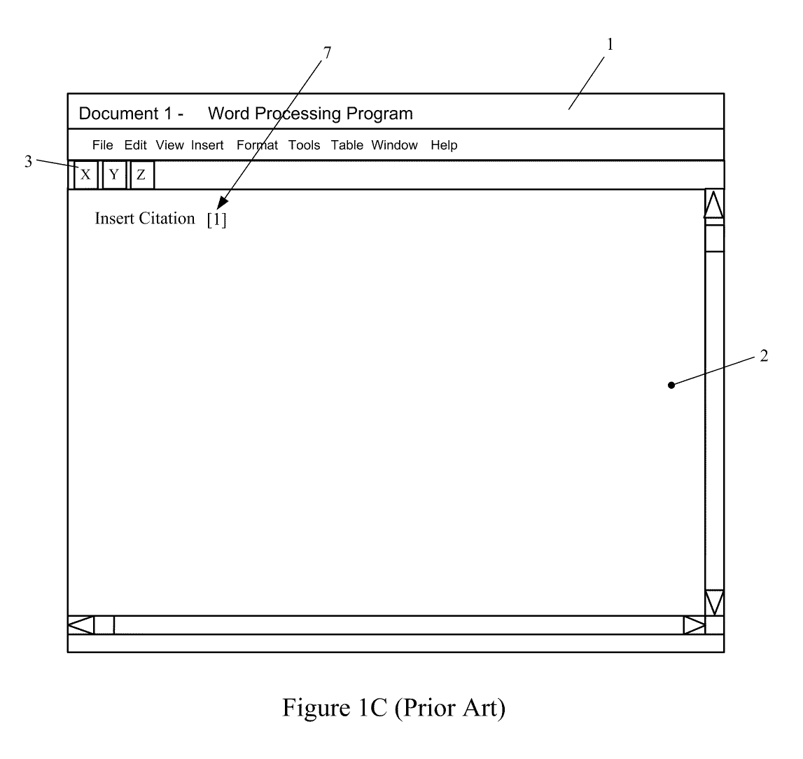

### DETAILED DESCRIPTION

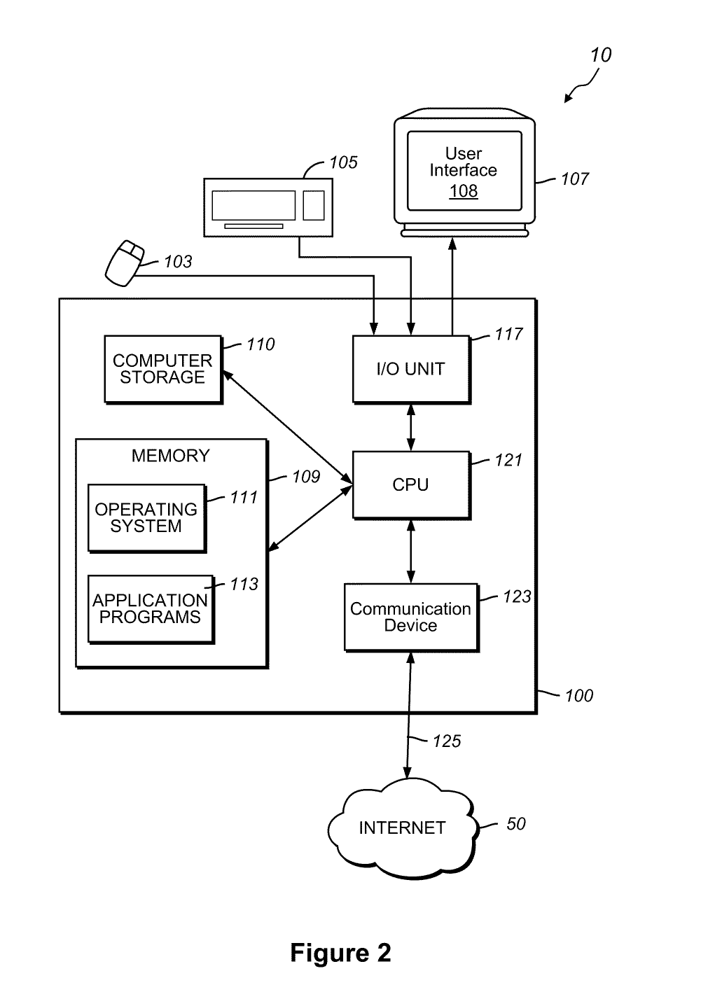

Referring to FIG. 2, a computer system 10 compatible with the disclosed invention includes a computer 100 that can include a central processor unit (CPU) 121, an I/O unit 117, a computer storage 110, and a memory 109 that stores data and programs such as an operating system 111 and one or more application programs 113. The application programs 113 can include a web browser and a word processing and editing program that is capable of inserting citations. The computer storage 110 can be a hard disk drive, CD-ROM, flash memory, and other removable storage media and can be implemented in many types of storage media based on magnetic, optical, and mechanical properties, and nano materials, which can include a hard drive and an array of hard drives, flash memory, optical disks, and magnetic tapes. The computer system 10 can be implemented on a device that has computation power, for example, a personal computer, a laptop computer, a portable computer, and a mobile device such as a smart phone or a personal digital assistant. The computer system 10 also includes a mouse 103, a keyboard 105, and a display 107 that can support a user interface 108. The computer system 10 can also include a touch pad or a touch screen interface as in a laptop computer, a tablet computer, and other computing devices. The computer 100 also includes a communications device 123 configured to exchange data with an Internet 50 via a communications link 125 such as optical fiber, telephone line, or a wireless connection.

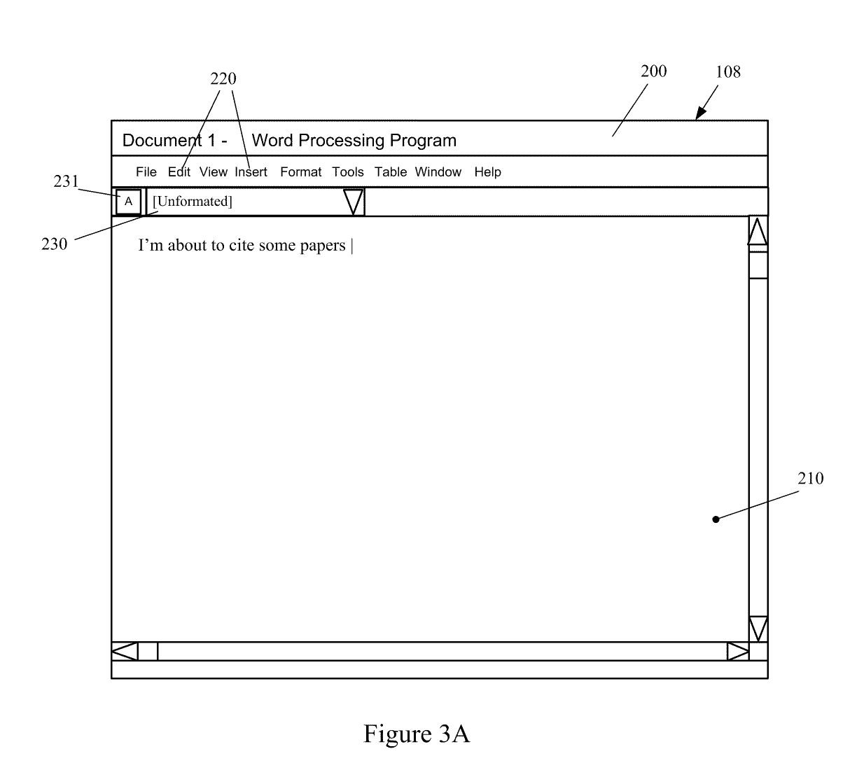

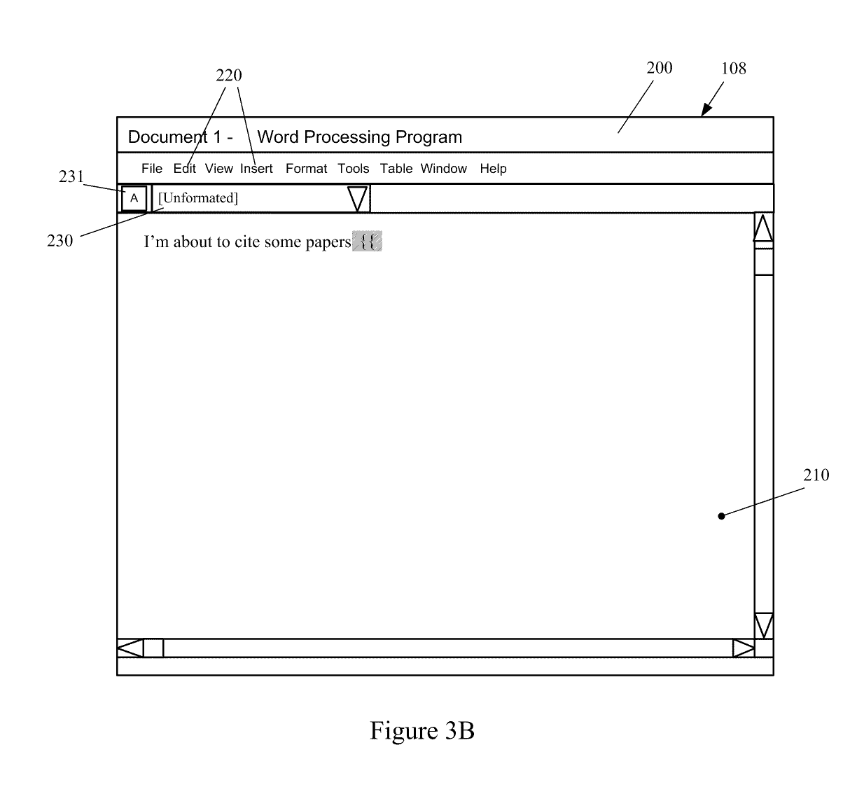

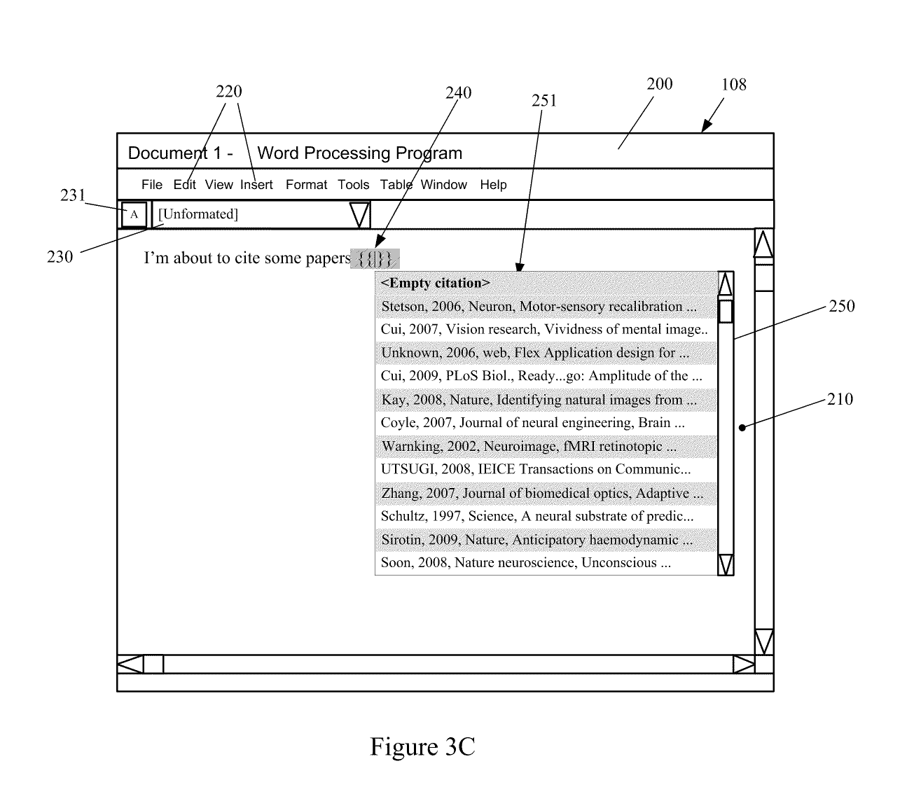

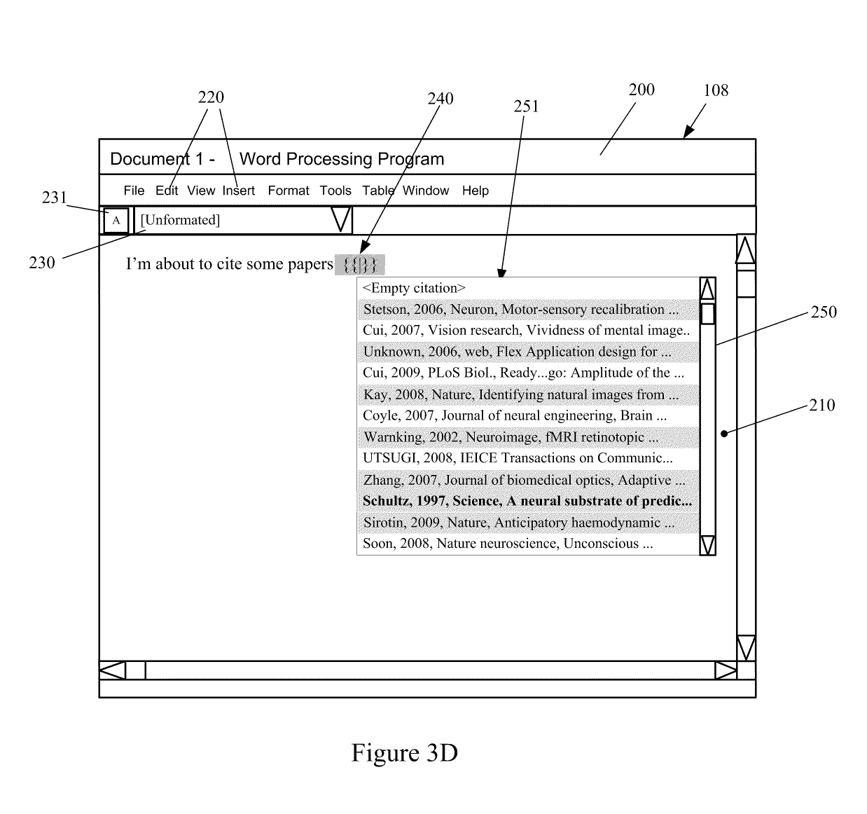

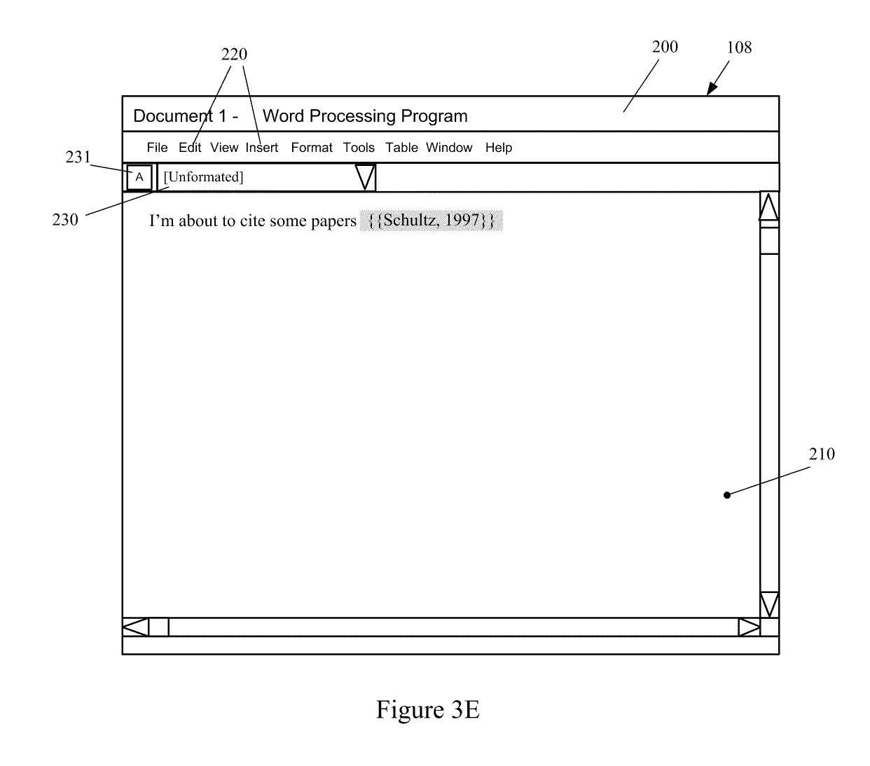

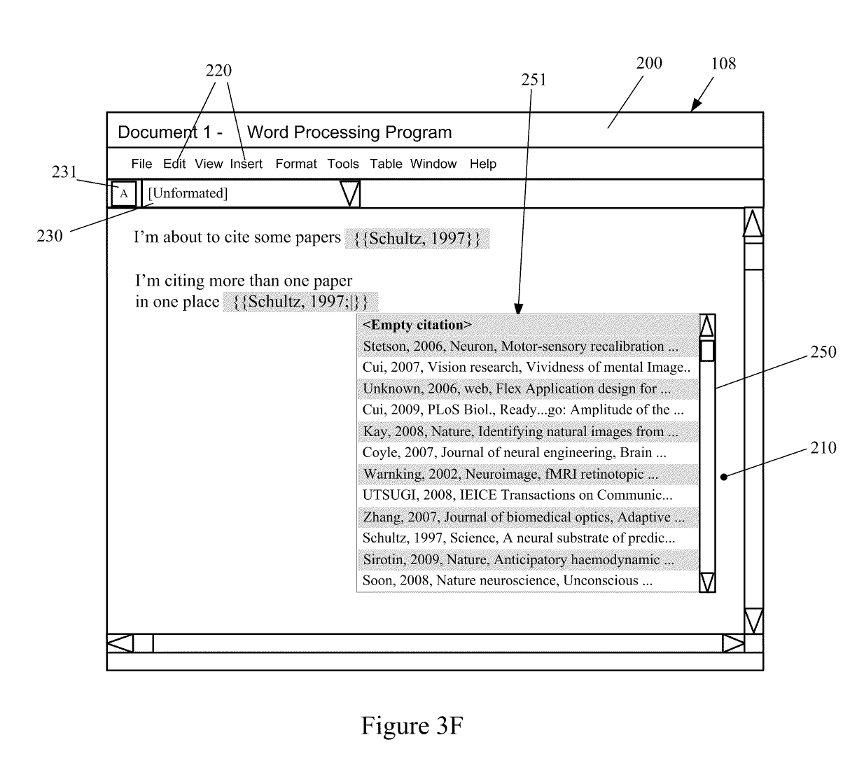

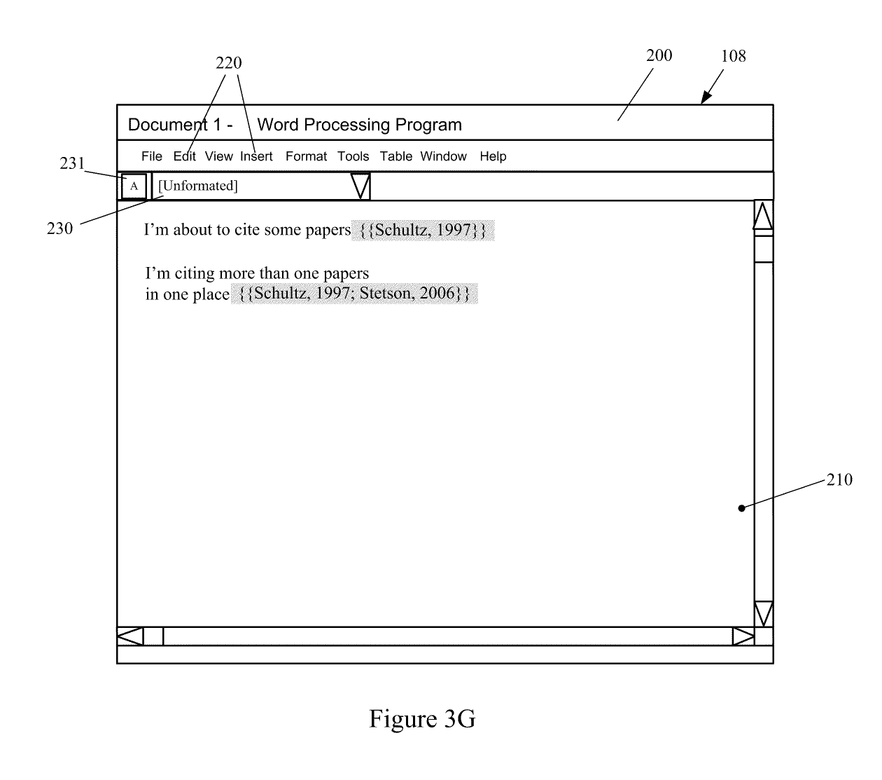

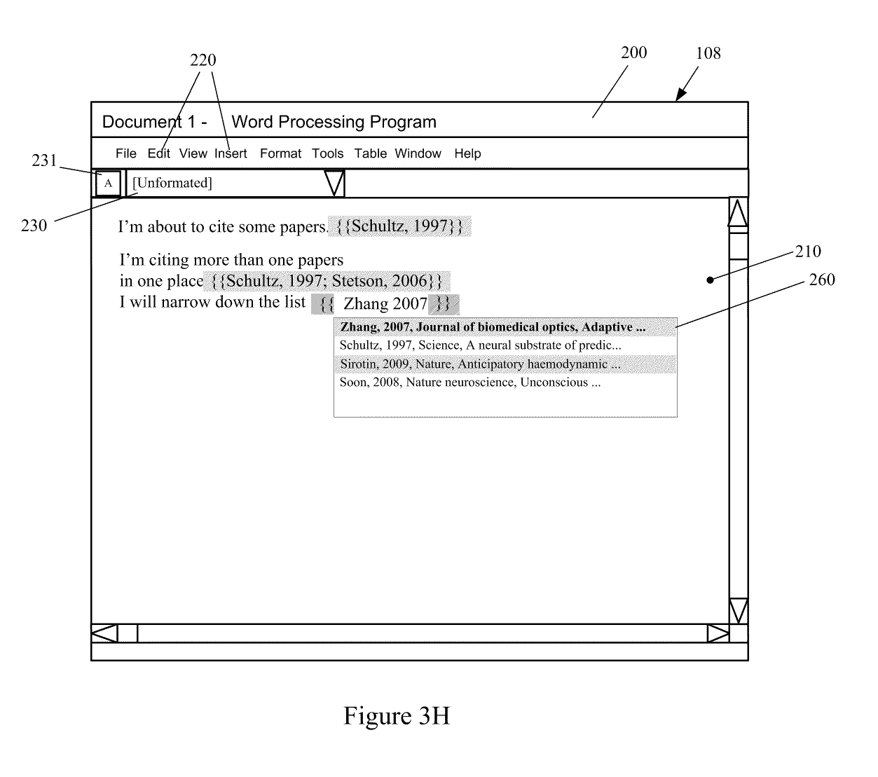

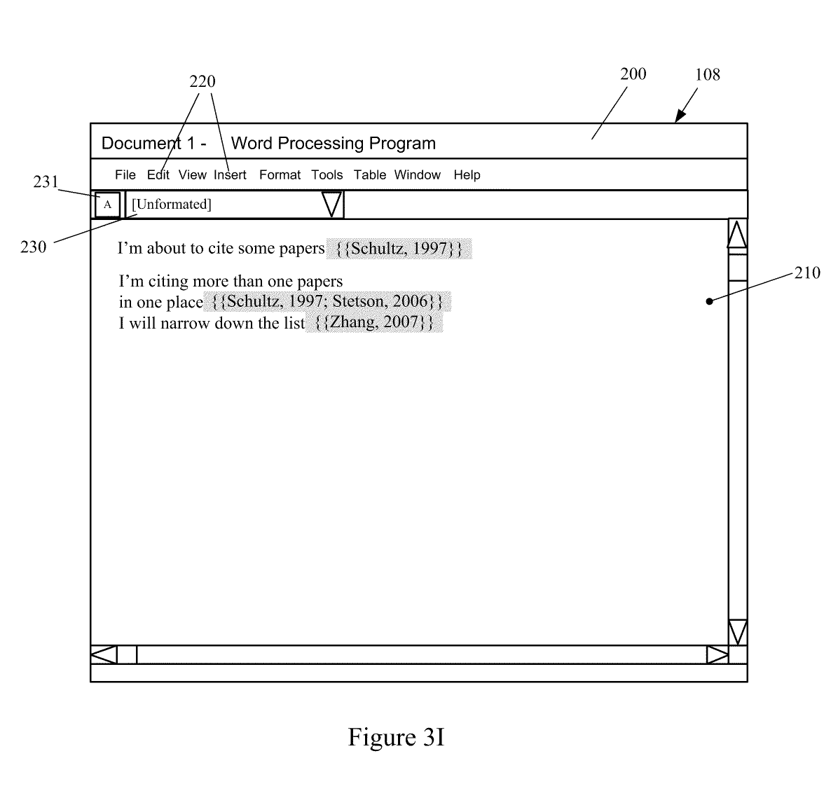

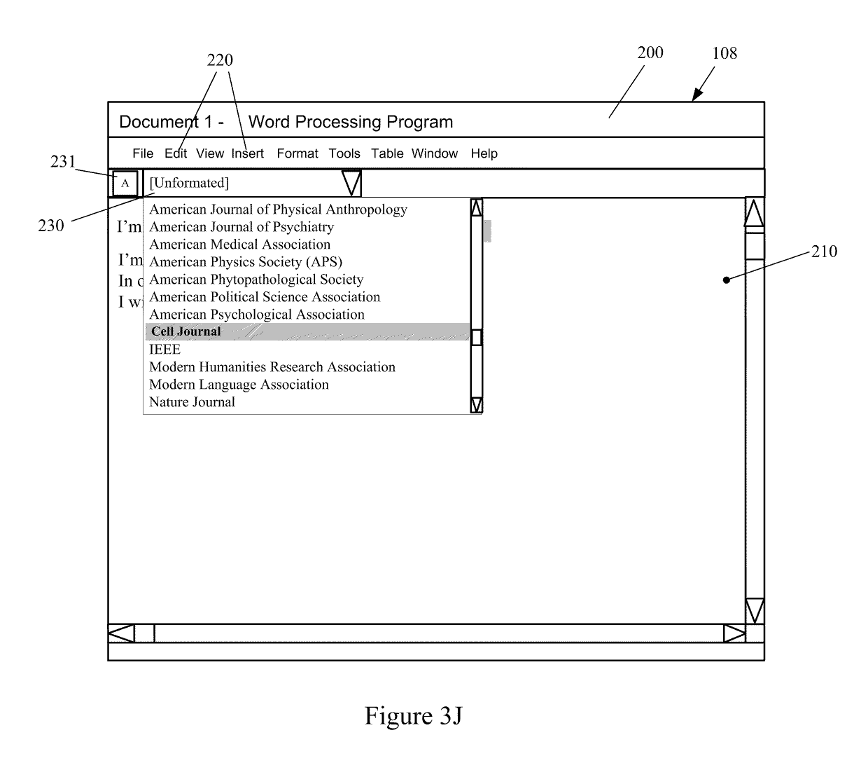

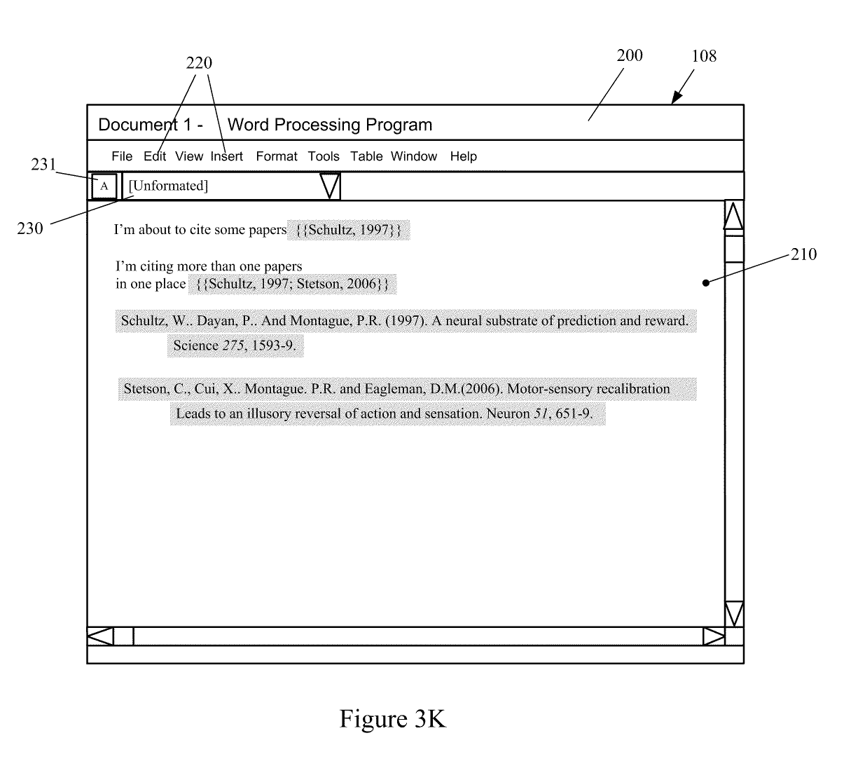

Referring to FIGS. 3A-3J, an exemplified user interface 108 includes a word processing environment 200 provided by a word processing program such as MS office suite, Mac iWork suite, Open Office, Word Perfect, Notepad, WordPad, WPS, Google Docs, and other word processing programs. The word processing environment 200 can be implemented as a window on a desk top. A plug-in (also called add-in) can be installed in the word processing program, or a stand alone program can be installed independent to the word processing program, for inserting citations in accordance with the present invention. The word processing environment 200 includes a text field 210 for a user to enter and edit text with the keyboard 105 (for a tablet computer, one can use a touch sensitive virtual keyboard to enter and edit text, as well as for inserting citation references as described below). The word processing environment 200 also includes activatable word-processing functions 220 in the categories such as “File”, “Edit”, “View”, “Insert”, “Format”, “Tools”, “Table”, “Window” and “Help”, and as described in more detail below, a function 230 for selecting the format of scientific citations.

The user first uses a keyboard (105, FIG. 2) to enter some text such as “I am about to cite some papers” in the text field 210 (FIG. 3A). To inset a citation such as a scientific publication, the user types on the keyboard a symbol which can include one or more special characters such as “{{” (FIG. 3B). The user can type “{{ }}” to define the field for the publication insertion. The symbol is only a marker for inserting one or more citation(s) and is not part of the text content intended by the user.

When the user type the special characters (such as “{{”), a list of citation references 250 automatically appears next to the special characters (FIG. 3C). The list of citation references 250 are collected by the user in the field that the writing is about, or publications shared by a group of co-workers or collaborators, or publications stored in a public server (such as USPTO database). The list of citation references 250 can be stored in the computer storage 110 and cached in the memory 109 when the application programs 113 are executed (FIG. 2). Alternatively, the citation references 250 can be stored on the local computer storage 110 and retrieved into the memory 109 when the symbol for citation reference is typed in the text area 210. The citation references 250 can also be stored on and retrieved from a remote server or storage device. The citation references 250 can be a portion of a long reference list. The citation references 250 can be displayed in an order according to the frequency of the user's usage with the most often cited references on top. The citation references 250 can also be displayed in a random out of a long list of references.

The list of citation references 250 can include an “Empty citation” option 251 (as shown on the top of the list of citation references 250 in FIG. 3C). The “Empty citation” allows the user not to select any reference in the list of citation references 250 and to enter citation manually using the keyboard 105. The “empty citation” also allows the user to insert and edit a citation in the future. For example, the user can insert a reminder about a reference she needs to insert in the future.

Closing symbols such as “}}” can automatically appear to enclose the reference and the cursor in the text area 210. The user can use an arrow key to move down the list of citation references 250 followed by pressing the “Enter” key to select a reference “Schultz, 1977” (FIG. 3D). Alternatively, the user can use mouse to select and insert a reference. The reference automatically appears next to the special characters “{{” (FIG. 3E). Without breaking the workflow, the user continues to use keyboard to type more text in the text field 210 “I am citing two or more papers at one location” (FIG. 3F). To insert more than one citations in one place, the user can insert the first reference (e.g. “Schultz, 1977”) as described above. The user then types another special character, such as “;”, right after the first reference (e.g. “Schultz, 1977”). A list of citation references again appears. The user can use the arrow key to select a second reference (e.g. “Stetson, 2006”). Both references separated by “;” are displayed within the special characters “{{” and “}}” (FIG. 3G).

In some embodiments, the user can search and narrow down the list of citation references by typing information about the reference to be inserted. As shown in FIG. 3H, the user types an author name “Zhang” within the special characters “{{” and “}}”. In response to the user typed information, the user interface 108 displays a dynamic list of citation references 260 that all include the typed author name “Zhang”. The user can easily select and insert a reference in this dynamic list (FIG. 3I). As the information about the reference is entered by the user, the program continuously searches available citation references and returns those citation references that contain the words that the user has just typed. The returned citation references are shown in the dynamic list of citation references 260. The citation references can be stored in a database file having fields such as “author”, “title”, “year”, “journal” etc. The citation references can also be stored a flat file or other data formats.

Once the references are inserted using the special characters such as “{{”, “}}” and “;”, the user can use the function 230 to select the format of scientific citations (FIG. 3J). The function 230 can include, for example, a pull-down menu that lists different citation format that are required by different publishers, scientific journals, and magazines (FIG. 3J). Once the user selects a citation format (e.g. Cell Journal), all the cited references are displayed in the selected citation format (FIG. 3K). The function 230 can include an “Unformatted” option which allows users to remove the format that is applied to the current document.

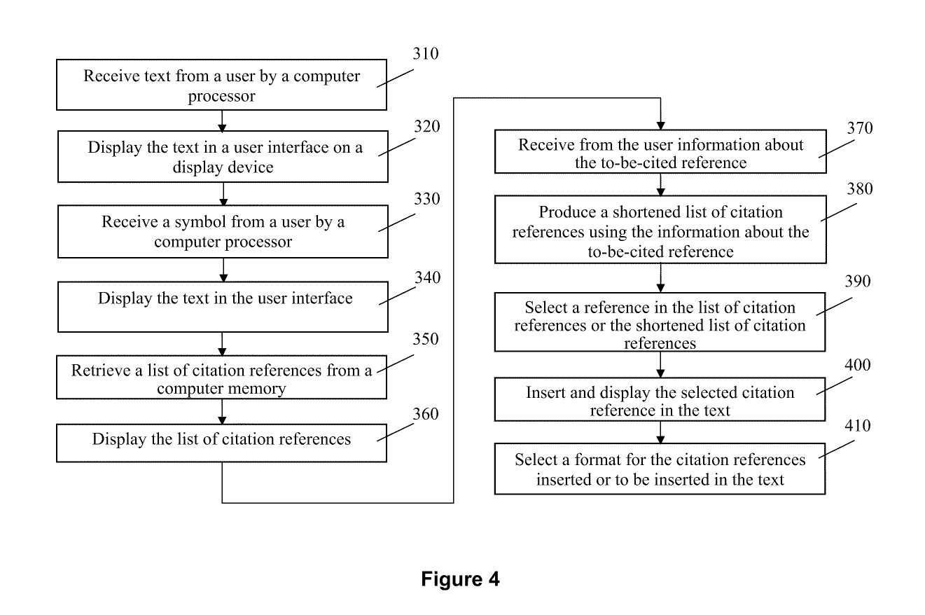

The insertion of citations in a word editing environment can include the following steps: text is first entered by a user and received by a computer processor (e.g. the CPU 121, FIG. 2) (step 310, FIG. 4). The text is displayed in a user interface on a display device (step 320, FIG. 4). A symbol that includes one or more special characters is received from the user (step 330, FIG. 4). The symbol is displayed on the display device (step 340, FIG. 4). A list of citation references are retrieved (e.g. from a computer memory, the computer storage 110, or the Internet, FIG. 2) (step 350, FIG. 4). The list of citation references are displayed in the user interface (step 360, FIG. 4). Optionally, the user types information related to the to-be-cited reference within or in adjacent to the special characters, which is received by the computer processor (step 370, FIG. 4). References are selected from the list of citation references to produce a new list of citation references in accordance to the user's input (step 380, FIG. 4). A citation reference is selected from the list of citation references or the new list of citation references (step 390, FIG. 4). The selected citation reference is inserted and displayed in the text (step 400, FIG. 4). A format can be selected by the user for the citation references already inserted or to be inserted in the text (step 410, FIG. 4).

It should be understood that the above-described methods are not limited to the specific examples used. Configurations and processes can vary without deviating from the spirit of the invention. For example, the symbol is not limited to the example used above. The symbol can include one or a combination of keystrokes that are not commonly used in text content. For example, the symbol can include one or more of “#”, “̂”, “&”, “*”, “˜”, “{”, “}”, “[”, “]”, “<”, “>”, “;”, “((”, or “))”. In the rare event that one of these characters is entered as part of the intended text content, the user can simply click the button 231 (FIGS. 3A-3K) to keep the symbol entered without inserting a citation.

Moreover, the appearance of the list of citation reference may not require the cursor to be placed between special characters. For example, the symbol can include “$$”; the list of citation references can appear right after the typing of the second “$” without the need of moving the cursor.

In some embodiments, instead of typing special characters, a functional key or a combination of keys on the keyboard can be pressed to activate the retrieval and display of the list of citation references. Examples of the functional keys include “F1”, “F2”, “F3”, etc. An example of a key combination include simultaneous pressing two or more of “Control”, “Shift”, and “Alt” keys. The pressing of a functional key or a combination of keys does not display any additional symbol or characters in the text, and does not break the user's workflow as the user can continue to use the keyboard without using a mouse. The functions of the functional key or key combination are pre-defined in the application program (113, FIG. 2) such as a plug-in to a word processing or a web browser program.

What is claimed is:

1. A computer-implemented method for creating citations for a document, comprising:
receiving, by a computer processor, text from a user via a keyboard in communication with the computer processor;
displaying the text on a user interface on a display device in communication with the computer processor;
receiving a symbol from the user via the keyboard, wherein the symbol is not part of the content of the text;
displaying the symbol adjacent to the text in the user interface;
retrieving, by the computer processor, a first list of citation references from a computer storage after the symbol is displayed in the user interface;
displaying the first list of citation references at the user interface to allow at least one of the first list of citation references to be selected; and
inserting the selected citation reference near the symbol in the text in the user interface.

2. The computer-implemented method of claim 1, further comprising:
selecting at least one of the first list of the citation references by the user before the step of inserting.

3. The computer-implemented method of claim 2, wherein the step of selecting is conduced by the user using the keyboard.

4. The computer-implemented method of claim 1, wherein the user interface comprises:
a word processing environment that includes a text field configured to display text entered by the user; and
an activatable function configured to receive a selection of a citation format for the selected reference in the text displayed in the user interface.

5. The computer-implemented method of claim 1, wherein the user interface comprises an activatable function, the computer-implemented method further comprising:
activating the activatable function after the symbol is displayed adjacent to the text at the user interface; and
skipping the insertion of the selected citation reference while keeping the symbol displayed adjacent to the text.

6. The computer-implemented method of claim 1, further comprising:
selecting, by the user, a citation format for the citation reference in the text displayed in the user interface.

7. The computer-implemented method of claim 1, further comprising:
receiving, from the user, information about the citation reference to be inserted; and
producing a dynamic list of citation references to allow the user to select a citation reference in the dynamic list of citation references.

8. The computer-implemented method of claim 1, wherein the symbol comprises one or “#”, “̂”, “&”, “*”, “˜”, “{”, “}”, “[”, “]”, “<”, “>”, “;”, “((”, or “))”.

9. A computer-implemented method for creating citations for a document, comprising:
receiving, by a computer processor, text from a user via a keyboard in communication with the computer processor;
displaying the text at a user interface on a display device in communication with the computer processor;
retrieving, by the computer processor, a first list of citation references from a computer storage in response to a keystroke or the pressing of a combination of keys on the keyboard;
displaying the first list of citation references in the user interface to allow at least one of the first list of the citation references to be selected; and
inserting the selected reference in the text at the user interface.

10. The computer-implemented method of claim 9, wherein the keystroke is executed by the pressing of one or more of a functional key, a “Control” key, an “Alt” key, or a “Shift” key on the keyboard.

11. The computer-implemented method of claim 9, wherein the keystroke or the pressing of a combination of keys on the keyboard does not produce a character or a symbol in adjacent to the text in the user interface.

12. The computer-implemented method of claim 9, further comprising:
selecting, by the user, a citation format for the citation reference in the text displayed in the user interface.

13. The computer-implemented method of claim 9, further comprising:
receiving, from the user, information about the citation reference to be inserted; and
producing a dynamic list of citation references to allow the user to select a citation reference in the dynamic list of citation references.

14. A computer program product comprising a computer useable medium having computer readable program code functions embedded in said medium for causing a computer to:
receive, by a computer processor, text from a user via a keyboard in communication with the computer processor;
display the text on a user interface on a display device in communication with the computer processor;
receive a symbol from the user via the keyboard, wherein the symbol is not part of the content of the text;
display the symbol adjacent to the text in the user interface;
retrieve, by the computer processor, a first list of citation references from a computer storage after the symbol is displayed in the user interface;
display the first list of citation references at the user interface to allow at least one of the first list of citation references to be selected; and
insert the selected citation reference near the symbol in the text in the user interface.

15. The computer program product of claim 14, wherein the computer readable program code functions embedded in said medium for causing a computer to allow the user to select at least one of the first list of the citation references before the step of inserting.

16. The computer program product of claim 15, wherein the at least one of the first list of the citation references is selected by the user using the keyboard.

17. The computer program product of claim 14, wherein the computer readable program code functions embedded in said medium for causing a computer to display in the user interface:
a word processing environment that includes a text field configured to display text entered by the user; and
an activatable function configured to receive a selection of a citation format for the selected reference in the text displayed in the user interface.

18. The computer program product of claim 14, wherein the computer readable program code functions embedded in said medium for causing a computer to display an activatable function in the user interface and to skip the insertion of the selected citation reference while keeping the symbol displayed adjacent to the text when the activatable function is activated after the symbol is displayed adjacent to the text at the user interface.

19. The computer program product of claim 14, wherein the computer readable program code functions embedded in said medium for causing a computer to receive selection from the user a citation format for the citation reference in the text displayed in the user interface.

20. The computer program product of claim 14, wherein the computer readable program code functions embedded in said medium for causing a computer to
receive from the user information about the citation reference to be inserted; and
produce a dynamic list of citation references to allow the user to select a citation reference in the dynamic list of citation references.
